(19) United States
(12) Patent Application Publication
(10) Pub. No.: US 2016/0042626 A1
(43) Pub. Date: Feb. 11, 2016

(54) Method and apparatus to prevent inadvertent death of a child

(71) Applicant: Tressie J. Beck, Glendale, AZ (US)

(72) Inventor: Tressie J. Beck, Glendale, AZ (US)

(21) Appl. No.: 14/756,022

(22) Filed: Jul. 22, 2015

Related U.S. Application Data
(60) Provisional application No. 61/999,320, filed on Jul. 23, 2014.

(51) Int. Cl. G08B 21/02; B60N 2/26

(52) U.S. Cl. CPC G08B 21/0205; B60N 2/26

(57) ABSTRACT

A method to prevent inadvertently leaving a child in a car seat in a vehicle utilizes a cannibalized glove. Finger stalls are removed from the cannibalized glove to permit a portion of a strap system to be threaded through the glove so that the glove is stored on the strap system when the car seat is not in use. The cannibalized glove is removed from the strap system and worn by a driver of the vehicle when a child is placed in the car seat. A portion of one or more finger stall is removed to produce a differential tactile result to increase the likelihood the driver will recollect the presence of a child in the car seat.

This application claims priority based on provisional patent application Ser. No. 61/999,320, filed Jul. 23, 2014.

This invention relates to methods and apparatus to reduce the frequency of inadvertent child deaths.

More particularly, it relates to minimizing the frequency of inadvertent child deaths by heat prostration, by drowning, by hypothermia, or by other circumstances which occur when a child is inadvertently left alone.

Those of skill in the art have for many years endeavored to develop processes and equipment to reduce the occurrence of inadvertent child deaths. Consequently, it would be highly desirable to provide improved processes and equipment to accomplish the same.

It is therefore a principal object of the invention to provide improved methods and apparatus to decrease the likelihood of inadvertent child deaths.

This, and other and further objects of the invention will be apparent to those skilled in the art from the following detailed description thereof, taken in conjunction with the drawings, in which:

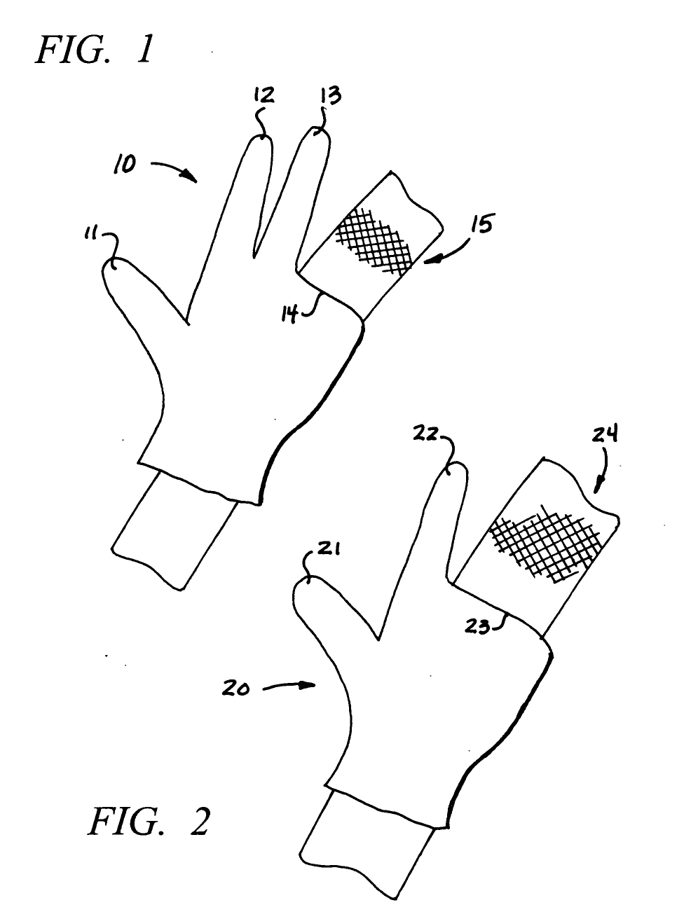

FIG. 1 is a front view illustrating the mode of operation of a cannibalized glove constructed and used in accordance with the invention;

FIG. 2 is a front view illustrating the mode of operation of another cannibalized glove constructed and used in accordance with the invention;

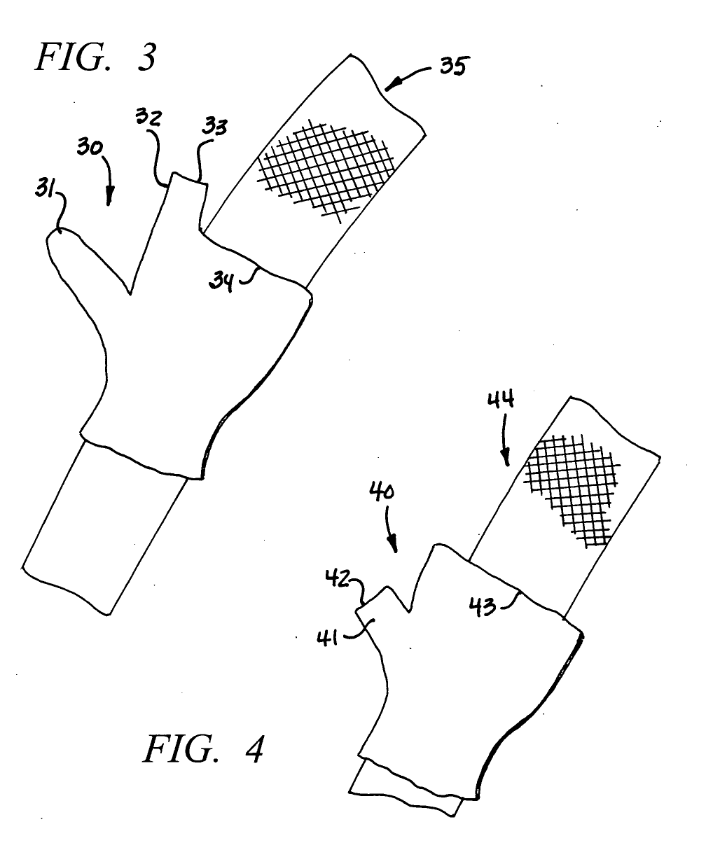

FIG. 3 is a front view illustrating the mode of operation of a further cannibalized glove constructed and used in accordance with the invention;

FIG. 4 is a front view illustrating the mode of operation of still another cannibalized glove constructed and used in accordance with the invention;

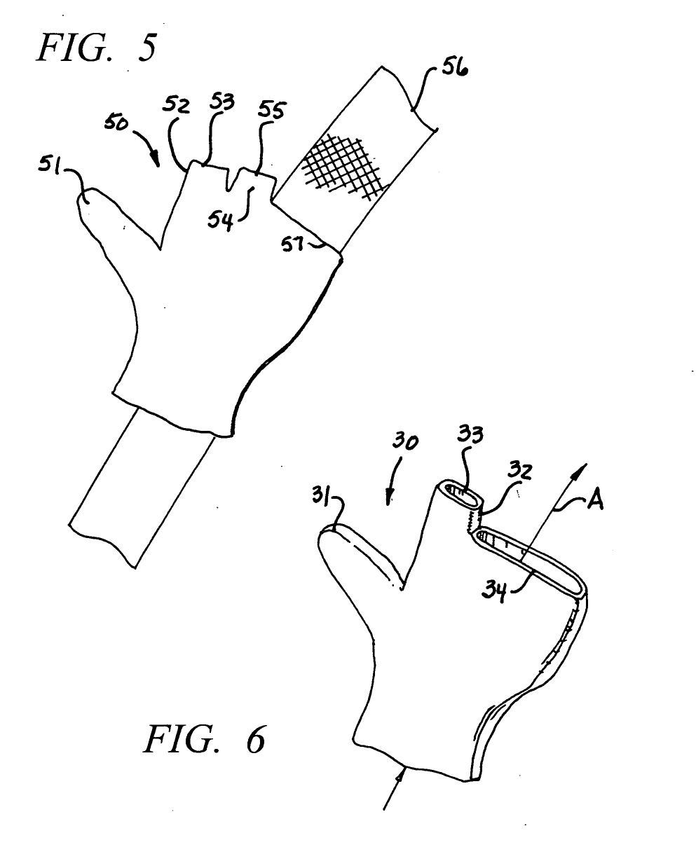

FIG. 5 is a front view illustrating the mode of operation of still a further cannibalized glove constructed and used in accordance with the invention;

FIG. 6 is a perspective view illustrating the glove of FIG. 3 illustrating additional construction details thereof;

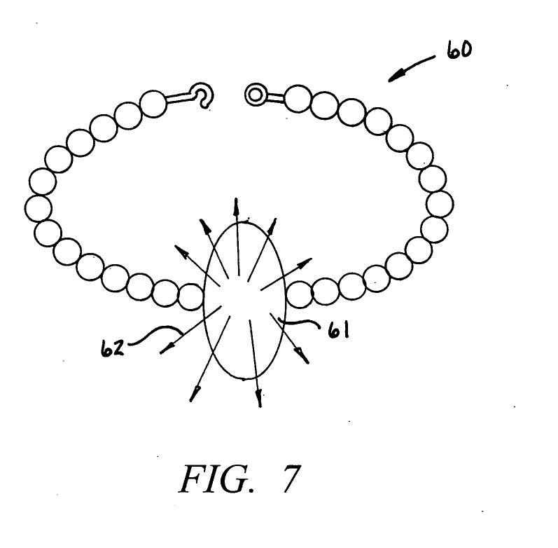

FIG. 7 is a front view illustrating a necklace constructed in accordance with the invention; and,

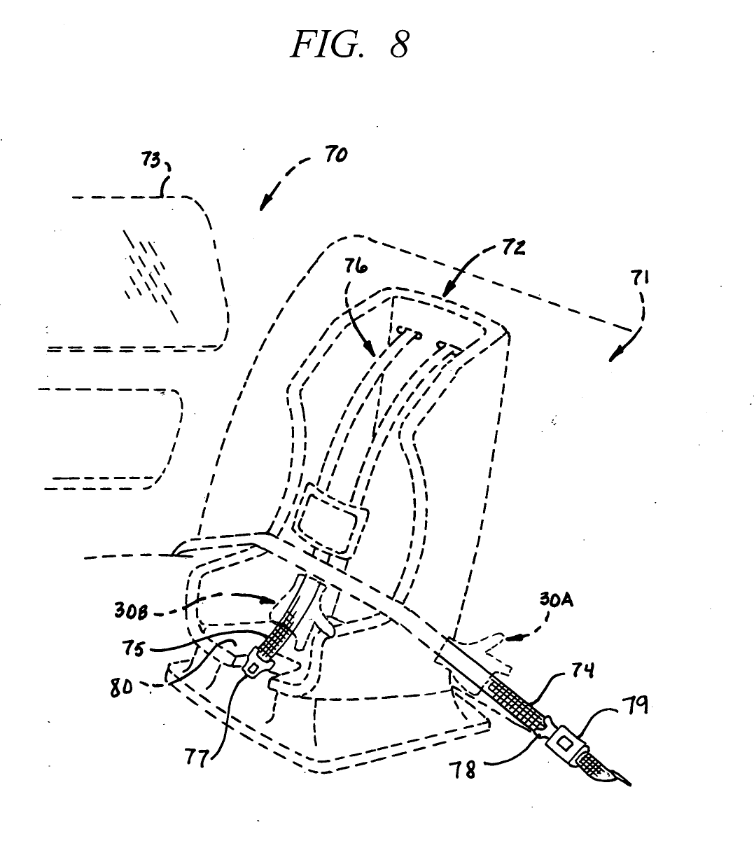

FIG. 8 is a perspective view illustrating the mode of operation of the cannibalized glove of the invention in conjunction with a child seat in the rear seat of a vehicle.

Briefly, provided in accordance with the invention is an improved method to prompt a vehicle driver of the presence of a child in the vehicle. The driver wears torso clothing having at least one major clothing pattern occupying at least 50% of the exterior visible area of the torso clothing. The method comprises the step of providing a vehicle. The vehicle includes a driver's seat; a steering wheel adjacent the driver's seat; a back seat; a child's seat in the back seat; and, a strap system to secure the child's seat in said back seat and a child in the child's seat. The method also includes providing a cannibalized glove having an exterior surface area and comprising at least a portion of a thumb stall; at least a portion of at least one finger stall; an opening produced by eliminating a plurality of finger stalls to permit a portion of the strap system to extend completely through the glove; at least one color on said exterior surface area having a brightness in the range of 100 to 255; and, at least one glove pattern occupying at least 50% of the exterior surface area of the glove and different from the clothing pattern on the torso clothing of the driver.

In another embodiment of the invention, provided is apparatus to prompt a vehicle driver of the presence of a child in the vehicle. The driver wears torso clothing having at least one externally visible major pattern occupying at least 50% of the torso clothing. The apparatus comprises a vehicle with a driver's seat; a steering wheel adjacent the driver's seat; a back seat; a child's seat in the back seat; and, a strap system to secure the child's seat in the back seat and a child in the child's seat. The apparatus also includes a cannibalized glove worn by the vehicle driver, removably mounted on the strap system to be removed and worn by the vehicle driver, and having an exterior surface area. The cannibalized glove also comprises at least a portion of a thumb stall; at least a portion of at least one finger stall; an opening produced by eliminating a plurality of finger stalls such that a portion of the strap system extends completely through the glove; at least one color on the exterior surface area having a perceived brightness in the range of 100 to 255; and, at least one pattern occupying at least 50% of the exterior surface area of the glove and different than the pattern on the torso clothing worn by the driver.

In a further embodiment of the invention, provided is an improved method to prompt a vehicle driver of the presence of a child. The driver wears torso clothing having at least one major pattern. The method comprises the steps of providing a mobile computerized device including computer software to send and receive text messages; and, providing a vehicle. The vehicle includes a driver's seat; a steering wheel adjacent the driver's seat; a back seat; a child's seat in the back seat; and, a strap system to secure the child's seat in the back seat and a child in the child's seat. The method also includes the step of providing a cannibalized tactile—differential glove having an exterior surface area. The glove comprises a portion of a thumb stall configured to permit the distal end of a thumb to extend outwardly away from the portion of the thumb stall; at least a portion of at least one finger stall; an opening produced by eliminating a plurality of finger stalls to permit a portion of the strap system to extend completely through the glove; at least one color having a perceived brightness in the range of 100 to 255; and, at least one pattern occupying at least 50% of said exterior surface area and different than the pattern of the torso clothing worn by the driver. The method also includes the steps of mounting the glove on a portion of the strap system; placing a child in the child seat; wearing the glove on a hand such that the distal end of the thumb on the hand extends outwardly away from the portion of the thumb stall, and the glove covers a portion of the hand; and, using at least the distal end of the thumb of the hand to send a text message on the mobile computerized device to produce a tactile differential between the distal end of the thumb and the portion of the hand covered by the glove.

Turning now to the drawings in which like reference characters refer to corresponding elements throughout the several views and which illustrate presently preferred embodiments of the invention without limitation thereof, FIG. 1 illustrates a cannibalized glove 10 including a thumb stall 11, finger stalls 12 and 13, and an opening 14 formed in glove 10 to permit it to be removably slidably mounted on a belt or strap 15 which comprises a portion of a strap or tie-down system 76 (FIG. 8) which is utilized to secure a child seat in the rear seat of a vehicle and to secure a child in the child seat.

FIG. 2 illustrates a cannibalized glove 20 including a thumb stall 21, a finger stall 22, and an opening 23 formed in glove 20 to permit glove 20 to be removably slidably mounted on a belt 24 which comprises a portion of a strap or tie-down system 76 which is utilized to secure a child seat in the rear seat of a vehicle and to secure a child in the child seat.

FIG. 3 illustrates a cannibalized glove 30 including a thumb stall 31, a portion 32 of a finger stall, and an opening 34 formed in glove 30 to permit glove 30 to be removably slidably mounted on a belt 35 which comprises a portion of a strap or tie-down system 76 which is utilized to secure a child seat in the rear seat of a vehicle and to secure a child in the child seat. When glove 30 is worn by an individual, the tip of an index finger of the individual extends outwardly through and from the opening 33 formed in portion 32 and is not covered by glove 30.

FIG. 4 illustrates a cannibalized glove 40 including a portion 41 of a thumb stall, and an opening 43 form in glove 40 to permit glove 40 to be removably slidably mounted on a belt 44 which comprises a portion of a strap or tie-down system 76 which is utilized to secure a child seat in the rear seat of a vehicle and to secure a child in the child seat. When glove 40 is worn by an individual, the distal end of a thumb of the individual extends outwardly through and from the opening 42 formed in portion 41 and is not covered by glove 40.

FIG. 5 illustrates a cannibalized glove 50 including a thumb stall 51, a portion 52 of a first thumb stall, a portion 54 of a second thumb stall, and an opening 57 formed in glove 50 which permits glove 50 to be removably slidably mounted on a belt 56 which comprises a portion of a tie-down system 76 which is utilized to secure a child seat in the rear seat of a vehicle and to secure a child in the child seat. When glove 50 is worn by an individual, the distal end of an index finger of the individual extends outwardly through and from the opening 53 formed in portion 52, and the distal end of a “middle finger” of the individual extends outwardly through and from the opening 55 formed in portion 54 of glove 50 such that the distal end of the middle finger is not covered by glove 50.

FIG. 6 is a perspective view of the glove 30 of FIG. 3, and illustrates how a strap 35 threads completely through glove 30 and outwardly through and from opening 34 in the manner indicated by arrow A, or, conversely, illustrates how glove 30 can be mounted on strap 35 by sliding glove 30 along strap 35 in the direction indicated by arrow A.

FIG. 7 illustrates a necklace or bracelet 60 which includes an amulet 61 which produces light 62. The necklace 60 is mounted on a child seat or a strap system used in conjunction with the child seat, and is removed and worn by the driver of a vehicle at the time the driver places a child in the child seat. Alternatively, the necklace 60 or glove 30 or hat or sunglasses or other article of clothing can be placed in some other location in the vehicle which will remind the driver to wear the necklace or glove when a child or animal is placed in the vehicle prior to the vehicle being driven by the driver. The article of clothing is designed to get the attention of the driver or another individual, either when the driver is removing the child or animal from the vehicle or has left the vicinity of the vehicle while inadvertently leaving the child or animal in the vehicle. The color or shape of the article of clothing is designed to draw attention to the article of clothing. The article of clothing can include a device which produces light or sound or a smell in order to gain the attention of the driver or of another individual. The light or sound or smell can be activated after the driver leaves the vehicle, preferably after the driver has left the vehicle for only a short period of time.

A cannibalized glove utilized in the invention can have any desired shape and dimension, provided that it preferably can, in accordance with currently preferred embodiments of the invention, be mounted on the strap system used to secure a child's seat in the rear seat of a vehicle and to secure a child in the child's seat. In most cases the cannibalized glove will be missing at least one finger stall found in a normal glove, this to form an opening (like opening 34 in FIG. 6) which permits a portion of a strap system operably associated with securing a child and child seat to be threaded completely through the glove and out the opening. Further, in most cases at least two finger stalls will be missing from the cannibalized glove. In one embodiment of the invention, however, the cannibalized glove retains all of its finger and thumb stalls (five stalls in total) and a slit is cut in the back or front of the glove to permit a strap to be threaded through the slit.

It is believed important, and critical, in one embodiment of the invention for a cannibalized glove to be slidably removably stored on a portion of a belt system 76 when there is not a child in a car seat in the rear seat of the vehicle. The belt system secures the child seat in place on the rear seat and secures a child in the child seat. Further, it is preferred that the glove be slidably removably stored on a portion of the belt system which must be handled by a driver when the driver is securing a child in the child seat. Further, it is preferred that the glove be slidably removably stored on a portion of the belt system which requires that the glove be removed—forcing the driver to handle the glove—before the belt system can be “latched” or otherwise configured to close or secure the belt system so that a child is secured in the child seat or the child seat is secured in the rear seat of a vehicle. Sliding the glove over a buckle which must be latched when securing a child in the child seat is one way to accomplish this. The various glove storage configurations described in this paragraph are critical because they help insures that a driver will see, and hopefully wear, the glove at the time the driver is securing a child in the child seat.

In FIG. 8, a child seat 72 is positioned in the rear or back seat 71 of a vehicle 70. Belt system 76 is used to secure seat 72 in position in the rear seat and to secure a child in the child seat. Belt system 76 includes, without limitation, belts 74 and 75. Vehicle 70 ordinarily includes one or more windows 73. The vehicle 70 also includes, in well known fashion, a driver's seat (i.e., a front seat), a steering wheel, a body, a suspension, axles, a plurality of ground engaging wheels mounted on the axles, motive powers means, doors or door openings, etc. (not shown). A cannibalized glove 30 can, by way of example and not limitation, be slidably removably mounted on belt 74 as indicated by dashed lines 30A. Glove 30 can also, by way of example and not limitation, be slidably mounted on belt 75 as indicated by dashed lines 30B. Buckle component 77 is equivalent to buckle component 78. Component 78 is, in FIG. 8, removably latched into receiving buckle component 79. Component 77 removably latches into a receiving buckle component which is comparable to component 79 and is beneath seat 80 and not visible in FIG. 8. In one preferred embodiment of the invention, glove 30B is mounted on belt 75 so that it covers buckle component 77, which requires a driver to actually grasp and remove glove 30 in order to latch component 77 into its receiving operatively associated buckle component.

In developing the invention, it was found that an individual wearing a cannibalized glove—particularly a glove missing one or more stalls or portions of a stall—caught the attention of the individual and of other individuals viewing the individual, presumably because the structure of the glove looked awkward and abnormal and often clashed with the normal appearance of and clothing worn by the individual. Gloves with finger stalls or portion of finger stalls missing are abnormal. This fits in with one objective of the invention which was defined during development of the invention, namely, trying insure that the glove when worn draws attention. Consequently, it was determined during development of the invention that it is preferred that the glove when worn does not look “fashionable” or “fit in” with clothing worn by a user. Rather, if anything, the glove should look garish or abnormal or grotesque in order draw attention to the glove when it is being worn by a user. For example, in one preferred embodiment of the invention, the cannibalized glove has, on its exterior, a visible background field of fluorescent yellow with green fluorescent spaced polka dot formed on the yellow field. Such a color combination rarely, if ever, fits in with clothing worn by a driver or is “fashionable”.

One characteristic of color is perceived brightness, as defined by the formula

brightness=sqrt(0.241 R2+0.691 G2+0.068 B2) [1]

This formula produces the brightness values set forth in the below table. See, for example:
http://www.nbdtech.com/Blog/archive/2008/04/27/Calculating-the-Perceived-Brig htness-of-a-Color.aspx
   Brighter colors function to draw attention to an object bearing the brighter color.

TABLE I
Perceived Brightness

| | | | |
|---|---|---|---|
| Black (0) | Navy (33) | Dark Blue (36) | Midnight Blue (37) |
| Indigo (50) | Medium Blue (53) | Maroon (62) | Blue (66) |
| Dark Red (68) | Purple (71) | Saddle Brown (89) | Dark Violet (91) |
| Firebrick (92) | Blue Violet (96) | Dark Olive Green (99) | Dark Orchid (100) |
| Sienna (104) | Dim Gray (1050 | Slate Blue (105) | Medium Violet Red (105) |
| Green (106) | Royal Blue (109) | Crimson (110) | Teal (111) |
| Forest Green (117) | Sea Green (119) | Dark Cyan (121) | Medium Slate Blue (122) |
| Steel blue (122) | Olive (123) | Red (125) | Slate Gray (125) |
| Medium Orchid (127) | Gray (128) | Indian Red (128) | Olive Drab (129) |
| Medium Purple (130) | Deep Pink (131) | Light Slate Gray (133) | Chocolate (135) |
| Orange Red (137) | Dodger Blue (137) | Magenta (141) | Fuchsia (141) |
| Dark Goldenrod (143) | Cadet Blue (145) | Cornflower Blue (146) | Pale Violet Red (147) |
| Peru (150) | Tomato (150) | Orchid (152) | Medium Sea Green (154) |
| Light Sea Green (155) | Rosy Brown (155) | Hot Pink (159) | Light Coral (162) |
| Salmon (165) | Dark Gray (169) | Violet (170) | Dark Orange (170) |
| Lime Green (172) | Dark Salmon (172) | Deep Sky Blue (172) | Goldenrod (174) |
| Dark Sea Green (175) | Dark Turquoise (179) | Dark Khaki (180) | Plum (181) |
| Medium Aquamarine (183) | Sandy Brown (183) | Light Salmon (185) | Tan (185) |
| Medium Turquoise (185) | Orange (185) | Yellow Green (186) | Burly Wood (191) |
| Silver (192) | Light Steel Blue (193) | Sky Blue (193) | Light Sky Blue (194) |
| Turquoise (196) | Thisle (199) | Light Pink (202) | Light Blue (207) |
| Pink (209) | Medium Spring Green (211) | Lime (211) | Light Gray (211) |
| Light Green (213) | Powder Blue (213) | Spring Green (214) | Lawn Green (218) |
| Gold (218) | Gainsboro (219) | Chartreuse (220) | Aqua (222) |
| Cyan (222) | Pale Turquoise (224) | Peach Puff (225) | Pale Green (225) |
| Wheat (225) | Aquamarine (227) | Khaid (227) | Navajo White (227) |
| Green Yellow (228) | Pale Goldenrod (229) | Lavender (231) | Moccasin (231) |
| Bisque (232) | Misty Rose (234) | Antique White (237) | Bleached Almond (238) |
| Linen (241) | Papaya Whip (241) | Beige (243) | Lavender Blush (244) |
| White Smoke (244) | Old Lace (245) | Yellow (246) | Alice Blue (246) |
| SeaShell (246) | Light Cyan (247) | Light Goldenrod Yellow (247) | Cornsilk (247) |
| Lemon Chiffon (248) | Ghost White (248) | Honeydew (250) | Floral White (250) |
| Snow (251) | Azure (251) | Mint Cream (252) | Light Yellow (253) |
| Ivory (254) | Transparent (255) | White (255) | |

Note:
The number following the color name indicates the perceived brightness with white at 255 having the greatest perceived brightness and black at 0 (zero) having the least perceived brightness.

While a cannibalized glove constructed in accordance with the invention can have on its exterior any desired color or colors, it is presently preferred that a cannibalized glove incorporate a color(s) having a brightness which is 150 or more, i.e., is at least 150. The size of the exterior area over which a color extends can vary. A bright color which covers only a limited area of the exterior area but which is against a dark background can be quite noticeable. In one embodiment of the invention, a color having a brightness of 150 or more extends over at least 15% of the visible exterior surface area of a cannibalized glove, preferably over at least 50% of the exterior surface area of a cannibalized glove, more preferably over at least 75% of the exterior surface area, and most preferably over at least 90% of the exterior surface area.

Further, a cannibalized glove used in the practice of the invention preferably has a color which significantly contrasts from and is different than the color of clothes worn by a user. For example, a hot pink glove normally will significantly contrast from clothing worn by many individuals, as will a fluorescent yellow or light green glove. A key purpose of the invention is to make the appearance of a cannibalized glove much different from that of clothing worn by a user, particularly different from that of clothing worn on the torso or upper body of the user. Examples of color pairs which, per the well known color wheel, are “complementary” and therefore provide significant contrast are red and green, violet and yellow, orange and blue, blue-violet and yellow-orange, blue-green and red-orange, and red-violet and yellow-green.

In addition, while a cannibalized glove used in the practice of the invention can have on its exterior surface area any desired pattern, it is presently preferred that a cannibalized glove have a pattern which contrasts with and is distinct from patterns found on clothing worn by a user, in particular with respect to the clothing worn on the upper body or torso of a user. One pattern used on the exterior of a cannibalized glove can simply consist of using a single color over the entire exterior surface area of the glove. A checkerboard pattern, polka dot pattern, lined pattern, or any other desired pattern can be utilized as long as the glove contrasts (i.e., is different) from the clothing worn by a user. It is preferred that the glove when worn does not look “fashionable” or “fit in” with clothing worn by a user. Rather, if anything, the glove should look garish in order draw attention to the glove when it is being worn by a user. For example, in one preferred embodiment of the invention, the cannibalized glove has on its exterior surface a background field of fluorescent yellow with green fluorescent spaced polka dot formed on the yellow field.

In use, according to one embodiment of the invention, a method is provided to prompt a vehicle driver of the presence of a child in the vehicle. The driver wears visible torso clothing having at least one major pattern. A major pattern is a pattern which covers or is integrated with on on at least 50% of visible exterior surface area of the clothing. The method includes the step of providing a vehicle 70 which includes a driver's seat, a steering wheel adjacent the driver's seat, a back or rear seat 71, a child's seat 72 positioned in the back seat, and a strap system 76 to secure the child's seat 72 in the back seat and a child in the child's seat 72. The method also includes the step of providing a cannibalized glove 30A. Glove 30A has an exterior surface area which is visible to the driver and to individuals standing adjacent the driver. Glove 30A also comprises at least a portion of a thumb stall 31; at least a portion 32 of at least one finger stall; an opening 34 produced by eliminating a plurality of finger stalls to permit a portion (35, 74, 75) of the strap system 76 to extend completely through the glove 30A; at least one color having a perceived brightness in the range of 100 to 255; and, at least one pattern occupying at least 50% of the exterior surface area of the glove and different than the pattern of the torso clothing worn by the driver. The method also includes the steps of placing the glove 30A on the strap system 76; removing and wearing glove 30A when strapping a child in the child's seat; strapping the child in the child's seat; driving, while wearing glove 30A the vehicle to a desired location; and, stepping out of the vehicle after arriving at the desired location. At some point after stepping out of the vehicle the glove reminds, if necessary, the driver, or reminds an individual adjacent the driver, that the child is in the back seat and must be removed from the back seat. For purposes herein a child can comprise an individual who is no more than fourteen years of age, preferably no more than twelve years of age, more preferably no more than ten years of age, and most preferably no one than eight years of age.

In one preferred embodiment of the invention a tactile differential cannibalized glove is utilized. This glove utilizes a thumb stall 41 (FIG. 4) which includes only a portion of a conventional thumb stall. A conventional thumb stall covers, of course, the entire thumb of a hand inserted in a glove. Thumb stall 41 permits the distal end and tip of a thumb to extend outwardly from stall 41 such that the distal end and tip of the thumb are not covered by the glove. Alternatively, a tactile differential cannibalized glove utilizes at least one finger stall 32 (FIG. 3) which includes only a portion of a convention finger stall. Finger stall 32 permits the distal end and tip of a finger to extend outwardly from stall 32 such that the distal end and tip of the finger are not covered by the glove. Or, in another embodiment of the tactile differential cannibalized glove, a thumb stall 41 and at least one finger stall 32 are included, each of which includes only a portion of a conventional thumb or finger stall, respectively. A tactile differential glove is a preferred embodiment because it frees the distal end of the thumb and/or finger to be utilized in texting, emailing, and other operations of a mobile device, which mobile computerized device typically includes a touch sensitive screen. As is well known, a touch sensitive screen utilized in an iPhone™, iPad™ or other mobile computerized device is touched at selected locations on the screen in order to select and “type” a letter, number, or other symbol that is used in a text message or email that is sent utilizing the mobile device, is used in making a telephone call, or used to record data on the device. More importantly, a tactile differential cannibalized glove is utilized in the practice of a preferred embodiment of the invention because it provides a tactile differential which is abnormal in everyday life and is more likely to draw the user's attention to the fact that there is a child in the user's vehicle. The tactile differential is produced by the glove because (1) the tip of the thumb and/or finger(s) has a normal tactile sensitivity since the glove does not cover the tip of the thumb and/or finger(s); and, the palm or other portions which are covered by the glove do not have a normal tactile sensitivity. The tactile sensitivity of the palm or other portions of the hand covered by the glove typically have less tactile sensitivity, or, at least have a tactile sensitivity which is different from the tactile sensitivity which those such portions of the hand have when a glove is not worn on the hand. Accordingly, one differential in tactile sensitivity is the tactile sensitivity of the uncovered thumb and finger tips as compared to the tactile sensitivity of the portions of the hand which are covered by the tactile differential cannibalized glove. A second differential in tactile sensitivity is the tactile sensitivity which the covered portions of the hand experience in comparison to the tactile sensitivity which the covered portions of the hand experience when the glove is not worn and the “covered portions” are no longer covered by the glove. During development of the invention, the incorporation and use of tactile sensitivity in connection with preventing inadvertently leaving a child in a vehicle was identified and believed to be a critical component of one embodiment of the invention because the differential in tactile sensitivity produce by the cannibalized glove of the invention is abnormal and make it significantly more likely that a user will have his or her attention drawn to the glove and recognize that a child is in a child seat in the rear of the vehicle. Such use of tactile sensitivity apparently has not been utilized in addressing the problem addressed by the invention.

Having described my invention in such terms as to enable those of skill in the art to understand and practice it, and having described embodiments thereof,

I claim:

1. A method to prompt a vehicle driver of the presence of a child, said driver wearing torso clothing having at least one major pattern, said method comprising the steps of
(a) providing a vehicle with
(i) a driver's seat,
(ii) a steering wheel adjacent the driver's seat,
(iii) a back seat,
(iv) a child's seat in said back seat,
(v) a strap system to secure said child's seat in said back seat and a child in said child's seat;
(b) providing a cannibalized glove having an exterior surface area and comprising
(i) at least a portion of a thumb stall,
(ii) at least a portion of at least one finger stall,
(iii) an opening produced by eliminating a plurality of finger stalls to permit a portion of said strap system to extend completely through said glove,
(iv) at least one color having a perceived brightness in the range of 100 to 255, and
(v) at least one pattern occupying at least 50% of said exterior surface area and different than the pattern of the torso clothing worn by the driver;

2. Apparatus to prompt a vehicle driver of the presence of a child, said driver wearing torso clothing having at least one externally visible major pattern occupying at least 50% of the torso clothing, said apparatus comprising
(a) a vehicle with
(i) a driver's seat,
(ii) a steering wheel adjacent the driver's seat,
(iii) a back seat,
(iv) a child's seat in said back seat,
(v) a strap system to secure said child's seat in said back seat and a child in said child's seat;
(b) a cannibalized glove worn by the vehicle driver, removably mounted on said strap system to be removed and worn by the vehicle driver, having an exterior surface area, and comprising
(i) at least a portion of a thumb stall,
(ii) at least a portion of at least one finger stall,
(iii) an opening produced by eliminating a plurality of finger stalls such that a portion of said strap system removably extends completely through said glove,
(iv) at least one color on said exterior surface area having a perceived brightness in the range of 100 to 255, and
(v) at least one pattern occupying at least 50% of said exterior surface area and different than the pattern on the torso clothing worn by the driver.

3. A method to prompt a vehicle driver of the presence of a child, said driver wearing torso clothing having at least one major pattern, said method comprising the steps of
(a) providing a mobile computerized device including computer software to send and receive text messages;
(b) providing a vehicle with
(i) a driver's seat,
(ii) a steering wheel adjacent the driver's seat,
(iii) a back seat,
(iv) a child's seat in said back seat,
(v) a strap system to secure said child's seat in said back seat and a child in said child's seat;
(c) providing a cannibalized tactile—differential glove having an exterior surface area and comprising
(i) a portion of a thumb stall configured to permit the distal end of a thumb to extend outwardly away from said portion of said thumb stall,
(ii) at least a portion of at least one finger stall,
(iii) an opening produced by eliminating a plurality of finger stalls to permit a portion of said strap system to extend completely through said glove,
(iv) at least one color having a perceived brightness in the range of 100 to 255, and
(v) at least one pattern occupying at least 50% of said exterior surface area and different than the pattern of the torso clothing worn by the driver;
(d) mounting said glove on a portion of said strap system;
(e) placing a child in said child seat;
(f) wearing said glove on a hand such that
(i) the distal end of the thumb on said hand extends outwardly away from said portion of said thumb stall, and
(ii) said glove cover a portion of said hand;
(g) using at least said distal end of said thumb of said hand to send a text message on said mobile computerized device to produce a tactile differential between said distal end of said thumb and the portion of said hand covered by said glove.
